(19) United States
(12) Patent Application Publication
(10) Pub. No.: US 2024/0379995 A1
(43) Pub. Date: Nov. 14, 2024

(54) Protected Anode Active Materials, Anode, and Sodium Ion Battery

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/316,765

(22) Filed: May 12, 2023

(51) Int. Cl. H01M 10/054; H01M 4/04; H01M 4/62; H01M 10/0568; H01M 10/0569

(52) U.S. Cl. CPC H01M 10/054; H01M 4/0492; H01M 4/622; H01M 4/625; H01M 10/0568; H01M 10/0569; H01M 2004/021; H01M 2004/027; H01M 2004/028; H01M 2300/0025

(57) ABSTRACT

A sodium-ion battery containing an anode, a cathode, and an electrolyte in ionic contact with the anode and the cathode, wherein the anode comprises multiple M-containing porous particulates (M=Sn, Sb, Si, Ge, Bi, Pb, P, an alloy thereof, or a compound thereof) and at least one of the porous particulates comprises (i) a porous host particle having pores and pore walls, wherein the porous host particle is electrically conducting having an electrical conductivity of no less than 10⁻⁶ S/cm; and (ii) one or a plurality of M particles residing in the pores or M coating deposited on the pore walls; wherein the pores have a pore volume fraction from 5% to 99.9% of the host particle and an empty (unoccupied) pore volume having an empty pore volume-to-Si volume ratio from 1/100 to 4/1 with the presence of M.

### FIELD

The present invention provides a method of producing porous particulates comprising an anode active material (e.g., Sn, Ge, Si, Sb, Bi, and P) deposited in the pores of porous host particles (e.g., carbon, graphite, graphene, Cu, and Al particles) for use in the anode (negative electrode) of a rechargeable sodium battery.

### BACKGROUND

Rechargeable lithium-ion (Li-ion) and lithium metal batteries (including Li-sulfur and Li metal-air batteries) are considered promising power sources for electric vehicle (EV), hybrid electric vehicle (HEV), and portable electronic devices, such as lap-top computers and mobile phones. Lithium as a metal element has the highest capacity (3,861 mAh/g) compared to any other metal or metal-intercalated compound as an anode active material (except Li_{4.4}Si, which has a specific capacity of 4,200 mAh/g). Hence, in general, Li metal batteries have a significantly higher energy density than lithium-ion batteries. However, lithium is not an abundant element in the earth's crust and lithium is only mined in a very limited number of countries. There is fear for short supply of lithium as the EV industry is rapidly emerging and, hence, the demand for lithium batteries can outpace the supply of lithium.

As a totally distinct class of energy storage device, sodium (Na) batteries have been considered an attractive alternative to lithium batteries since sodium is abundant and the production of sodium is significantly more environmentally benign compared to the production of lithium. In addition, the high cost of lithium is a major issue and Na batteries potentially can be of significantly lower cost.

There are at least two types of batteries that operate on bouncing sodium ions (Nat) back and forth between an anode and a cathode: the sodium metal battery having Na metal or alloy as the anode active material and the sodium-ion battery having a Na intercalation compound as the anode active material. Sodium ion batteries using a hard carbon-based anode active material (a Na intercalation compound) and a sodium transition metal phosphate as a cathode have been described by several research groups; e.g., J. Barker, et al. “Sodium Ion Batteries,” U.S. Pat. No. 7,759,008 (Jul. 20, 2010).

However, these sodium-based devices exhibit even lower specific energies and rate capabilities than Li-ion batteries. The anode active materials for Na intercalation and the cathode active materials for Na intercalation have lower Na storage capacities as compared with their Li storage capacities. For instance, hard carbon particles are capable of storing Li ions up to 300-360 mAh/g, but the same materials can store Na ions up to 150-250 mAh/g. Graphite typically stores significantly less than 150 mAh/g of sodium ions (often less than 40 mAh/g) even though graphite can store up to 370 mAh/g of lithium.

Instead of hard carbon or other carbonaceous intercalation compound, sodium metal may be used as the anode active material in a sodium metal cell. However, the use of metallic sodium as the anode active material is normally considered undesirable and dangerous due to the dendrite formation, interface aging, and electrolyte incompatibility problems. Further, sodium is known as a highly explosive substance.

Silicon (Si) can be a good candidate anode material for a sodium-ion battery. However, Si suffers from some severe problems induced by Si volume changes when the sodium-ion cell is charged and discharged. An anode active material is normally used in a powder form, which is mixed with conductive additives and bonded by a binder resin. The binder also serves to bond the mixture to a current collector. Alternatively, an anode active material may be coated as a thin film onto a current collector. On repeated charge and discharge operations, the Si particles tend to undergo pulverization and the current collector-supported thin films are prone to fragmentation due to expansion and contraction of the anode active material (Si) during the insertion and extraction of sodium ions. This pulverization or fragmentation results in loss of particle-to-particle contacts between the active material and the conductive additive or contacts between the anode material and its current collector. These adverse effects result in a significantly shortened charge-discharge cycle life. In addition to Si, other elements, such as Ge, Sn, Bi, Sb, Pb, P, their alloys (e.g., SnGe, SnSb, NiSb, and SnGeSb), and their compounds (e.g., Sn₄P₃ and SnO₂), are also candidate anode materials for sodium-ion batteries and they also suffer from similar issues as Si, but to varying degrees.

It is generally believed that the nanostructured and amorphous forms of silicon provide mechanical integrity with reduced pulverization due to the reduced number density of atoms within a nano-sized grain and the ‘free volume’ effects in amorphous silicon which results in better capacity retention and cycle life. Further, due to the presence of defects and absence of long range order in amorphous silicon, the volume expansion upon sodium insertion can be distributed homogenously and the net effect of crack formation and propagation can be less catastrophic compared to crystalline silicon. Hence, the amount of pulverization of the active material is significantly reduced which gives rise to enhanced capacity retention and cyclability.

Amorphous silicon is generally obtained by physical and chemical vapor deposition methods. Physical vapor deposition methods include RF or magnetron sputtering and pulsed laser deposition using silicon targets. Chemical vapor deposition methods include thermal, microwave or plasma assisted decomposition of silicon precursors such as silane, SiH₄. These techniques, though commonly implemented in the electronics industry, are not economically viable for secondary batteries. Secondary batteries used for consumer portable electronic devices and electric vehicles are subject to very stringent demands of competitive price reduction. Therefore, there is a need to explore alternative cost-effective approaches for generation of amorphous silicon. Although electro-deposition was attempted to produce anode electrodes (not the anode active material particles per se) for lithium-ion cells (not for sodium-ion cells), these electrodes are too thin and do not have a high areal capacity, resulting in lower energy densities of the cells.

When the sodium-ion cell is assembled and filled with electrolyte, the anode and cathode active materials have a difference in potential of at most about 1.5-2 volts between the two. The difference in potential between the two electrodes, after the first sodium-ion charge, is about 3 volts. When the sodium-ion cell is charged for the first time, sodium is extracted from the cathode and introduced into the anode. As a result, the anode potential is lowered significantly (toward the potential of metallic sodium), and the cathode potential is further increased (to become even more positive). These changes in potential may give rise to parasitic reactions on both electrodes, but more severely on the anode. For example, a decomposition product known as solid electrolyte interface (SEI) readily forms on the surfaces of anode carbon materials, wherein the SEI layer comprises sodium and electrolyte components. These surface layers or covering layers are sodium-ion conductors which establish an ionic connection between the anode and the electrolyte and prevent the reactions from proceeding any further.

Formation of this SEI layer is therefore necessary for the stability of the half-cell system comprising the anode and the electrolyte. However, as the SEI layer is formed, a portion of the sodium introduced into the cells via the cathode is irreversibly bound and thus removed from cyclic operation, i.e. from the capacity available to the user. This means that, during the course of the first discharge, not as much sodium moves from the anode back to the cathode as had previously been released to the anode during the first charging operation. This phenomenon is called irreversible capacity and is known to consume about 10% to 30% of the capacity of a sodium ion cell.

A further drawback is that the formation of the SEI layer on the anode after the first charging operation may be incomplete and will continue to progress during the subsequent charging and discharge cycles. Even though this process becomes less pronounced with an increasing number of repeated charging and discharge cycles, it still causes continuous abstraction, from the system, of sodium which is no longer available for cyclic operation and thus for the capacity of the cell. Additionally, as indicated earlier, the formation of a solid-electrolyte interface layer consumes about 10% to 30% of the amount of sodium originally stored at the cathode, which is already low in capacity (typically <150 mAh/g). Clearly, it would be a significant advantage if the cells do not require the cathode to supply all the required amount of sodium.

Therefore, in summary, a need exists for an anode active material that has a high specific capacity, a minimal irreversible capacity (or a low decay rate), and a long cycle life. In order to accomplish these goals, we have worked diligently and intensively on the development of new electrode materials, which are in a powder form and can be incorporated with an optional binder and optional conductive additive to form an anode (negative electrode) of high areal capacity. These research and development efforts lead to the present patent application.

### SUMMARY OF THE INVENTION

The present disclosure provides an anode active material for the anode (negative electrode) of a sodium battery (e.g. sodium-ion battery, sodium-sulfur battery, sodium-air battery, etc.), the sodium battery containing the anode, and a process for producing such an anode active material, the anode, and the battery cell. This new material enables the battery to deliver a significantly improved specific capacity and much longer charge-discharge cycle life.

In certain embodiments, the disclosed sodium battery comprises an anode, a cathode, and an electrolyte in ionic contact with the anode and the cathode, wherein the anode comprises multiple M-containing porous particulates, where M is an element selected from Si, Ge, Sn, Sb, Pb, P, Bi, an alloy thereof, a compound thereof, or a combination thereof, and at least one of the porous particulates comprises (i) a porous host particle having pores and pore walls, wherein the porous host particle is electrically conducting having an electrical conductivity of no less than 10⁻⁶ S/cm; and (ii) one or a plurality of M particles residing in said pores or M coating deposited on said pore walls; wherein the pores have a pore volume fraction from 5% to 99.9% of the host particle without the presence of M or prior to deposition of M in the host particle and an empty (unoccupied) pore volume having an unoccupied pore volume-to-Si volume ratio from 1/100 (or 0.01) to 4/1 (or 4.0) with the presence of M (after deposition of M in the pores of the host particle). M can be Si, Ge, Sn, Bi, Sb, Pb, P, their alloys (e.g., SnGe, SnSb, NiSb, and SnGeSb), and their compounds (e.g., Sn₄P₃ and SnO₂).

The sodium battery can comprise or is a sodium-ion cell, sodium-sulfur cell, sodium-selenium cell, or a sodium-air cell.

In certain embodiments, the M-containing porous particulates contain a residual (unoccupied) pore-to-Si volume ratio from 0.5 to 5.0 (preferably from 1.0 to 3.0). The M coating or M particles may preferably have a thickness or diameter from 1 nm to 1 μm. preferably from 10 nm to 500 nm and further preferably from 20 nm to 150 nm.

In certain embodiments, the porous host particles are selected from porous carbonaceous, graphitic, graphene, or metallic particles.

The porous graphene particles may comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof.

The porous carbonaceous or graphitic particles comprise particles of activated carbon, soft carbon, hard carbon, polymeric carbon, activated natural graphite, activated artificial graphite, exfoliated graphite worms, expanded graphite flakes, meso-phase carbon, needle coke, or a combination thereof.

Preferably, the host metallic particles comprise a metal selected from a transition metal (e.g., Cu, Zn, Ni, Co, Mn, Fe or steel, etc.), Al, Ga, In, Sn, Bi, an alloy thereof, or a combination thereof.

The M particles or coating in the porous particulates may be preloaded with an element selected from Li, Na, K, Al, or a combination thereof. Preferably, the anode active material is pre-sodiated (with a desired amount of Na atoms already permeated into the anode active material (i.e., M).

In certain embodiments, the porous particulates further comprise a thin protecting layer having a thickness from 0.5 nm to 2 μm and encapsulating or coating on the porous particulates, wherein the protecting layer comprises carbon, graphene, electron-conducting polymer, sodium ion-conducting polymer, or a combination thereof.

In certain embodiments, the protecting layer comprises a carbon material, graphene, a polymer, or a sodium- or sodium-containing species chemically bonded to said particulates and said sodium- or sodium-containing species is selected from Li₂CO₃, Li₂C₂O₄, LiOH, LiCl, LiI, LiBr, ROCO₂Li, HCOLi, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, Li₂O, Na₂O, NaF, LiF, a combination thereof, wherein X═F, Cl, I, or Br, R=a hydrocarbon group, x=0-1, y=1-4.

The protecting layer may comprise a thin layer of a high-elasticity polymer having a fully recoverable tensile strain from 5% to 1,000%, and a sodium ion conductivity from 10⁻⁷ S/cm to 5×10⁻² S/cm at room temperature.

The electrolyte in the sodium battery may be selected from solid polymer electrolyte, polymer gel electrolyte, composite electrolyte, ionic liquid electrolyte, non-aqueous organic liquid electrolyte, soft matter phase electrolyte, inorganic solid-state electrolyte, or a combination thereof.

The electrolyte may contain an alkali metal salt (preferably sodium salt or a mixture of sodium salt and lithium salt or potassium salt) selected from an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), a combination thereof, or a combination thereof with lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF3(CF₂CF₃)₃), or lithium bisperfluoroethysulfonylimide (LiBETI).

The electrolyte may comprise a solvent selected from ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol)dimethyl ether (PEGDME), diethylene glycol dibutyl ether (DEGDBE), 2-ethoxyethyl ether (EEE), sulfone, sulfolane, a room temperature ionic liquid, or a combination thereof.

In certain embodiments, the cathode comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Na(Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

In certain embodiments, the cathode comprises a cathode active material selected from a Na-based layered oxide, a polyanionic compound, a mixed polyanionic compound, a sulfate, a pyrophosphate, a Prussian Blue analog, or a combination thereof.

In certain embodiments, the cathode comprises a cathode active material selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}MnO_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

The present disclosure also provides a process for producing a solid powder mass of multiple individual Si-containing porous particulates (M═Si) for used in the sodium battery anode, the process comprising (a) providing a solid powder mass comprising multiple porous host particles having a volume fraction of pores from 5% to 99.9%, wherein the porous host particles are electrically conducting having an electrical conductivity of no less than 10⁻⁶ S/cm; (b) introducing a reactive liquid or solution, containing a Si precursor, into pores of the porous particles, and (c) exposing the reactive liquid or solution species to heat, ultra-violet light, laser beam, high-energy radiation (e.g., Gamma radiation, X-ray, and/or electron beam), or a combination thereof to convert the Si precursor into Si particles residing in the pores or into Si coating deposited on pore walls to obtain the solid powder mass of separate (non-bonded) multiple Si-containing porous particulates. These multiple Si-containing porous particulates are physically separate particles not bonded by any binder before they are made into an anode electrode at a later stage.

In some embodiments, the porous host particles are selected from carbonaceous, graphitic, graphene, or metallic particles. In some preferred embodiments, the reactive liquid or solution comprises silane-type species, as a Si precursor, selected from Cyclohexasilane (CHS), Hexasilane (HS), Cyclopentasilane (CPS), neo-pentasilane (NPS), isotectrasilane, trisilane, a chemical derivative thereof, a combination thereof; or a combination thereof with disilane or monosilane.

In certain preferred embodiments, the disclosure provides a process for producing a solid powder mass of multiple individual Si-containing porous particulates, the process comprising (a) providing a solid powder mass comprising multiple porous host particles having a volume fraction of pores from 5% to 99.9%, wherein the porous host particles are selected from carbonaceous, graphitic, graphene, or metallic particles; (b) introducing a reactive liquid or solution into pores of the porous particles wherein the reactive liquid or solution comprises silane-type species (polysilane) selected from Cyclohexasilane (CHS), Hexasilane (HS), Cyclopentasilane (CPS), neo-pentasilane (NPS), tectrasilane (e.g., isotectrasilane), trisilane, a chemical derivative thereof, a combination thereof; or a combination thereof with disilane or monosilane, and (c) exposing the silane-type species to heat, ultra-violet light, laser beam, high-energy radiation (e.g., Gamma radiation, X-ray, and/or electron beam), or a combination thereof to convert the silane-type species into Si particles residing in the pores or Si coating deposited on pore walls to obtain the solid powder mass of separate (non-bonded) multiple Si-containing porous particulates.

In general, the deposited anode active material (e.g., Si coating or particles) does not fully occupy the pores, allowing a sufficient amount of voids to accommodate the volume expansion of Si during the battery charging procedure. Most preferably, the residual pore-to-Si volume ratio is from 0.5 to 5.0, further preferably from 1.0 to 3.0. The Si coating or Si particles preferably have a thickness or diameter from nm to 1 μm, more preferably from 10 nm to 500 nm and further preferably from 20 nm to 150 nm.

The disclosure also provides an electrochemical process for producing a solid powder mass of multiple anode material particulates (for use in a sodium-ion battery anode), the process comprising (a) providing a working electrode comprising a solid powder mass comprising multiple porous host particles (e.g., porous carbonaceous particles, graphitic particles, graphene particles, or metal particles) having a dimension from 50 nm to 50 μm and a volume fraction of pores from 5% to 99.9% (pores preferably being interconnected); (b) dissolving or dispersing a source of a selected anode active material in a liquid electrolyte; (c) providing a counter electrode; and (d) disposing the working electrode, the liquid electrolyte, and the counter electrode in a first electrodeposition chamber and applying a desired current or voltage sequence across the working electrode and the counter electrode to electrodeposit an anode active material into the pores of the porous particles to obtain and recover the solid powder mass of separate or non-bonded multiple anode material articulates.

In general, the deposited anode active material (e.g., Si, Ge, Sn, Sb, Bi, their alloys, their compounds, etc.) does not fully occupy the pores; preferably occupying only 5-90% by volume of the pores and further preferably 30-70% by volume, allowing a sufficient amount of voids to accommodate the volume expansion of the anode active material during the battery charging procedure.

These particulates are in a powder form that can be readily incorporated with an optional binder and optional conductive additive to form an anode (negative electrode) of high areal capacity, typically higher than 4.5 mAh/cm², more typically higher than 6 mAh/cm², further typically and desirably higher than 10 mAh/cm², still more typically and desirably higher than 20 mAh/cm², 30 mAh/cm², 50 mAh/cm², etc. These high areal capacities normally could not be achieved if one chose to deposit pure Si directly on a current collector.

In certain embodiments, the anode active material is selected from silicon (Si), germanium (Ge), tin (Sn), Phosphorus (P), lead (Pb), antimony (Sb), bismuth (Bi), zinc (Zn), aluminum (Al), titanium (Ti), nickel (Ni), cobalt (Co), manganese (Mn), cadmium (Cd), or a combination thereof.

The anode active material source preferably comprises a material selected from SiCl₄, GeCl₄, SnCl₄, SiBr₄, GeBr₄, SnBr₄, SiI₄, GeI₄, SnI₄, SiHCl₃, GeHCl₃, SnHCl₃, SiHBr₃, GeHBr₃, SnHBr₃, SiHI₃, GeHI₃, SnHI₃, or a salt of Si, Ge, Sn, P, Pb, Sb, Bi, Zn, Al, Ti, Ni, Co, Mn, Cd, or a combination thereof.

The liquid electrolyte for this electrochemical process preferably contains a liquid selected from 1,3-dioxolane (DOL), 1,2-dimethoxyethane (DME), tetraethylene glycol dimethylether (TEGDME), poly(ethylene glycol)dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), tetrahydrofuran (THF), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, Hydrofluoro ether (IFE), Trifluoro propylene carbonate (FPC), Methyl nonafluorobutyl ether (MFE), Fluoroethylene carbonate (FEC), Tris(trimethylsilyl)phosphite (TTSPi), Triallyl phosphate (TAP), Ethylene sulfate (DTD), 1,3-propane sultone (PS), Propene sultone (PES), Alkylsiloxane (Si—O), Alkylsilane (Si—C), liquid oligomeric silaxane (—Si—O—Si—), Tetraethylene glycol dimethylether (TEGDME), canola oil, an ionic liquid, Tetramethylammonium chloride (TMACL), tetraethylammonium chloride (TEACL), tetrabutylammonium chloride (TBACL), tetrabutylammonium perchlorate (TBACLO), a tetraalkylammonium salt, or a combination thereof.

In certain embodiments, the porous graphene particles comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof.

The porous carbonaceous or graphitic particles preferably comprise particles of activated carbon, soft carbon (defined as a carbon material that is graphitizable), hard carbon (non-graphitizable even at a temperature higher than 2,500° C.), polymeric carbon (e.g., carbonized resin in a bulk, film, or fibrous form), activated natural graphite, activated artificial graphite, exfoliated graphite worms, expanded graphite flakes, meso-phase carbon, needle coke, or a combination thereof.

The host metallic particles preferably comprise a metal selected from a transition metal (e.g., Cu, Mn, Co, Ni, Ti), Al, Ga, In, Sn, Bi, an alloy thereof, or a combination thereof. The porous metallic particles, as a host, can be selected from Cu, Al, steel, Sn, Zn, Ti, Mn, Co, Ni, or any other transition metal. The metal may be coated with a passivation layer (e.g., carbon or polymer).

These particulates are in a powder form that can be readily incorporated with an optional binder and optional conductive additive to form an anode (negative electrode) of high areal capacity, typically higher than 4.5 mAh/cm², more typically higher than 6 mAh/cm², further typically and desirably higher than 10 mAh/cm², still more typically and desirably higher than 20 mAh/cm², 30 mAh/cm², 50 mAh/cm², etc. These high areal capacities normally could not be achieved if one chose to deposit M (e.g., neat Si) directly on a current collector.

The process may further comprise a procedure of encapsulating or coating the porous anode material particulates with a thin protecting layer having a thickness from 0.5 nm to 2 μm. The protecting lay preferably comprises carbon (e.g., amorphous carbon, polymeric carbon or carbonized polymer), graphene, electron-conducting polymer, sodium ion-conducting polymer, or a combination thereof.

In some embodiments, the process further includes a procedure of pre-sodiating the multiple anode material particulates, wherein the anode material particles are pre-sodiated to contain an amount of sodium from 1% to 100% of a maximum sodium content contained in the anode active material, M (i.e., Si, Sn, Ge, Sb, Bi, P, etc.).

The maximum sodium content in an active material may be defined as the theoretical capacity of this material. In certain preferred embodiments, the particle of anode active material comprises a doped semiconductor Si or Ge material, which is doped with n-type and/or p-type dopants.

The process may further comprise a procedure of encapsulating or coating the pre-sodiated anode material particulates with a thin protecting layer having a thickness from 0.5 nm to 2 μm. In some embodiments, the protecting layer comprises a carbon material, graphene, a polymer, or a lithium- or sodium-containing species chemically bonded to the particulates and the lithium- or sodium-containing species is selected from Li₂CO₃, Li₂C₂O₄, LiOH, LiCl, LiI, LiBr, ROCO₂Li, HCOLi, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, a combination thereof, a combination thereof with Li₂O or LiF, or a combination of Li₂O and LiF, wherein X═F, Cl, I, or Br, R=a hydrocarbon group, x=0-1, y=1-4.

In some embodiments, the protecting layer comprises a thin layer of a high-elasticity polymer having a fully recoverable tensile strain from 5% to 1,000%, and a sodium ion conductivity from 10⁻⁷ S/cm to 5×10⁻² S/cm at room temperature.

The process step of pre-sodiating may include a procedure selected from chemical pre-sodiation, electrochemical sodiation, solution sodiation, physical sodiation, or a combination thereof. In certain embodiments, the step of pre-sodiating includes conducting electrochemical pre-sodiation in the first electrodeposition chamber or in a second electrodeposition chamber different than the first chamber.

The process may further comprise a step of forming the multiple anode material particulates, along with an optional binder and optional conductive additive, into an anode electrode. The process may further comprise a step of combining the anode electrode with a cathode, and an electrolyte to form a battery cell.

The disclosure also provides a solid powder mass of multiple anode material particulates (e.g., containing Sn, Ge, Si, Sb, Bi, P, etc.) produced by the processes discussed above. Further disclosed is an anode electrode that comprises multiple anode material particulates produced by the described processes, an optional conductive additive, and an optional binder. Also disclosed is a sodium-ion or sodium metal battery containing the anode electrode described above, a cathode electrode, and an electrolyte in ionic contact with the anode electrode and the cathode electrode.

### BRIEF DESCRIPTION OF THE DRAWINGS

FIG. 1 Schematic of a process for producing porous conducting host particulates containing Si or prelithiated Si in the pores of the host particles, according to a preferred embodiment of the present disclosure using Si as an example.

FIG. 2 Schematic of an electrochemical process for pre-sodiating the deposited Si particles or coating in the pores of host particles, according to a preferred embodiment of the present disclosure, using Si as an example.

FIG. 3 Electrochemical potential of the electrolyte relative to those of the anode and the cathode in a battery cell. The anode can act as a reductant and the cathode an oxidant of the electrolyte.

FIG. 4(A) Schematic of an electrochemical process for electrodepositing an anode active material (e.g., Ge) into pores of carbon, graphite, or graphene particles, according to a preferred embodiment of the present invention.

FIG. 4(B) Schematic of another process for electrodepositing an anode active material into pores of carbon, graphite, or graphene particles, according to a preferred embodiment of the present invention.

FIG. 5 Schematic of a lithium-ion cell comprising an anode (supported by an anode current collector), a sodium ion-permeable separator or solid-state electrolyte, a cathode (supported by a cathode current collector), wherein the anode comprises multiple anode particulates, according to some embodiment of the present disclosure.

### DETAILED DESCRIPTION

This disclosure is related to anode materials for high-capacity sodium batteries, which are preferably secondary batteries based on a non-aqueous electrolyte, a polymer gel electrolyte, polymer electrolyte, quasi-solid electrolyte, inorganic solid-state electrolyte, or composite or hybrid electrolyte. The shape of a sodium battery can be cylindrical, square, button-like, etc. The present invention is not limited to any battery shape or configuration. The sodium battery can comprise or is a sodium-ion cell, sodium-sulfur cell, sodium-selenium cell, or a sodium-air cell.

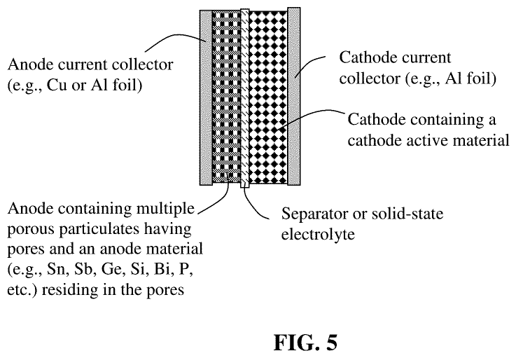

The disclosed sodium battery, as illustrated in FIG. 5, comprises an anode, a cathode, and an electrolyte in ionic contact with the anode and the cathode, wherein the anode comprises multiple M-containing porous particulates, where M is an element selected from Si, Ge, Sn, Sb, Pb, P, Bi, an alloy thereof, a compound thereof, or a combination thereof, and at least one of the porous particulates comprises (i) a porous host particle having pores and pore walls, wherein the porous host particle is electrically conducting having an electrical conductivity of no less than 10⁻⁶ S/cm; and (ii) one or a plurality of M particles residing in said pores or M coating deposited on said pore walls; wherein the pores have a pore volume fraction from 5% to 99.9% of the host particle without the presence of M or prior to deposition of M in the host particle and an empty (unoccupied) pore volume having an unoccupied pore volume-to-Si volume ratio from 1/100 (or 0.01) to 4/1 (or 4.0) with the presence of M (after deposition of M in the pores of the host particle).

Preferably, the M-containing porous particulates contain a residual (unoccupied) pore-to-Si volume ratio from 0.5 to 5.0 (more preferably from 1.0 to 4.0). The M coating or M particles may preferably have a thickness or diameter from 1 nm to 1 μm. preferably from 10 nm to 500 nm and further preferably from 20 nm to 150 nm.

The porous host particles are selected from porous carbonaceous, graphitic, graphene, or metallic particles. The porous graphene particles may comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof.

The porous carbonaceous or graphitic particles comprise particles of activated carbon, soft carbon, hard carbon, polymeric carbon, activated natural graphite, activated artificial graphite, exfoliated graphite worms, expanded graphite flakes, meso-phase carbon, needle coke, or a combination thereof. Preferably, the host metallic particles comprise a metal selected from a transition metal (e.g., Cu, Zn, Ni, Co, Mn, Fe or steel, etc.), Al, Ga, In, Sn, Bi, an alloy thereof, or a combination thereof.

The M particles or coating in the porous particulates may be preloaded with an element selected from Li, Na, K, Al, or a combination thereof. Preferably, the anode active material is pre-sodiated.

The porous particulates may further comprise a thin protecting layer having a thickness from 0.5 nm to 2 μm and encapsulating or coating on the porous particulates, wherein the protecting layer comprises carbon, graphene, electron-conducting polymer, sodium ion-conducting polymer, or a combination thereof. The protecting layer comprises a carbon material, graphene, a polymer, or a sodium- or sodium-containing species chemically bonded to said particulates and said sodium- or sodium-containing species is selected from Li₂CO₃, Li₂C₂O₄, LiOH, LiCl, LiI, LiBr, ROCO₂Li, HCOLi, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, Li₂O, Na₂O, NaF, LiF, a combination thereof, wherein X═F, Cl, I, or Br, R=a hydrocarbon group, x=0-1, y=1-4.

The protecting layer may comprise a thin layer of a high-elasticity polymer having a fully recoverable tensile strain from 5% to 1,000%, and a sodium ion conductivity from 10⁻⁷ S/cm to 5×10⁻² S/cm at room temperature.

The present disclosure provides several methods that can be used to produce the anode active materials, the anode (negative electrode), and the sodium battery containing such an anode.

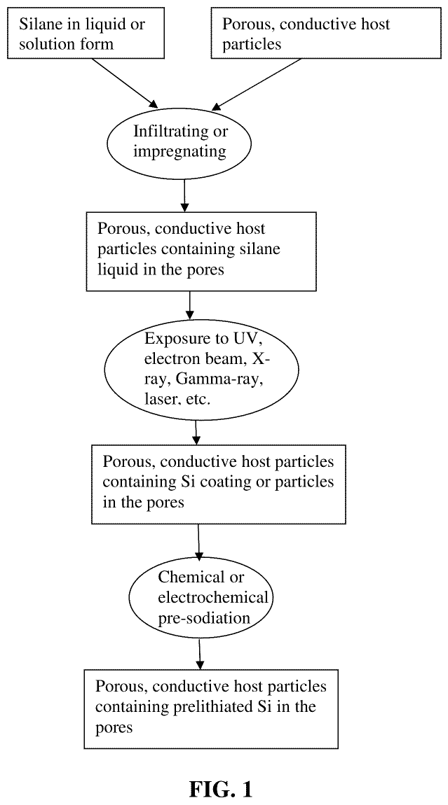

For instance, as illustrated in FIG. 1, the present disclosure provides a process for producing a solid powder mass of multiple individual Si-containing porous particulates for use in the anode of a sodium battery. Si is used as an example of M, which can be Ge, Sn, etc. The process comprises (a) providing a solid powder mass comprising multiple porous host particles (e.g., carbonaceous, graphitic, graphene, or metallic particles) having a volume fraction of pores from 5% to 99.9%, wherein the porous host particles are electrically conducting having an electrical conductivity of no less than 10⁻⁶ S/cm; (b) introducing a reactive liquid or solution, containing a Si precursor, into pores of the porous particles, and (c) exposing the reactive liquid or solution species to heat, ultra-violet light, laser beam, high-energy radiation (e.g., Gamma radiation, X-ray, and/or electron beam), or a combination thereof to convert the Si precursor into Si particles residing in the pores or into Si coating deposited on pore walls to obtain the solid powder mass of separate (non-bonded) multiple Si-containing porous particulates. These multiple Si-containing porous particulates are physically separate particles that are not bonded (e.g., sintered) to each other. They may later be glued together by any binder when they are made into an anode electrode at a later stage. The M coating or particles deposited in the pores may be subsequently pre-solidated using known chemical or electrochemical methods.

Again, these particulates are substantially separated from one another and are not bonded to one another with a binder. The pores inside the host particles are preferably interconnected to facilitate fast migration of the atoms or ions of M during the solution deposition process. The volume fraction of pores is preferably from 30% to 95% and most preferably from 50% to 90% prior to the inclusion of M in the pores.

The reactive liquid or solution comprises silane-type species, as a Si precursor, selected from Cyclohexasilane (CHS), Hexasilane (HS), Cyclopentasilane (CPS), neo-pentasilane (NPS), isotectrasilane, trisilane, a chemical derivative thereof, a combination thereof; or a combination thereof with disilane or monosilane. There are similar Ge-based molecules (Si replaced by Ge in the formulas) available for deposition of Ge coating or particles.

It may be noted that the simplest isomer of silane-type species is the one in which the silicon atoms are arranged in a single chain with no branches. This isomer is sometimes called the n-isomer (n for “normal”). However the chain of silicon atoms may also be branched at one or more points. The number of possible isomers increases rapidly with the number of silicon atoms. The members of the series (in terms of number of silicon atoms) and selected physical properties are shown in Table 1 below:

TABLE 1
Physical properties of small silanes:

| | | | | Density |
|---|---|---|---|---|
| | | Boiling point | Melting point | [g cm⁻³] |
| Silane | Formula | [° C.] | [° C.] | (at 25° C.) |
| Silane | SiH₄ | −112 | −185 | gas |
| Disilane | Si₂H₆ | −14 | −132 | gas |
| Trisilane | Si₃H₈ | 53 | −117 | 0.743 |
| Tetrasilane | Si₄H₁₀ | 108 | −90 | 0.793 |
| n-Pentasilane | Si₅H₁₂ | 153 | −72.8 | 0.827 |
| cyclopentasilane | Si₅H₁₀ | 194 | −10.5 | 0.963 |
| n-Hexasilane | Si₆H₁₄ | 193.6 | −44.7 | 0.847 |
| Cyclohexasilan | Si₆H₁₂ | 226 | 18 | 0.97 |

Their chemical formulas are given in the following schematics:

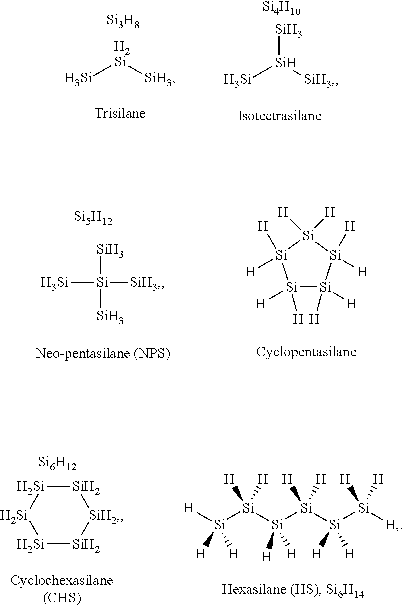

Non-limiting examples of the chemical derivatives of these silanes are decamethyl-Cyclopentasilane (C₁₀H₃₀Si₅), Hexabenzyl-cyclohexasilane, and tetradecamethyl-hexasilane (C₁₄H₄₂Si₆).

The Si deposition process can begin with impregnating the pores of porous host particles with a liquid silane. Among the various silanes, cyclohexasilane (CHS, Si₆H₁₂), Hexasilane (HS, Si₆H₁₄), Neo-pentasilane (NPS), Cyclopentasilane, and Tectrasilane are particularly useful because hey maintains a low vapor pressure and are stable in ambient light. They can be used for the solution-based synthesis of functional Si coating or particles inside pores. Using CHS as an example, the silane undergoes a ring-opening polymerization when exposed to heat or UV light, with thermal annealing transforming the polyhydrosilane to silicon. Liquid silane impregnation may be achieved by immersing the porous host particles in liquid silane (e.g., CHS) at room temperature. The liquid, before and after impregnation, may be exposed to UV irradiation to initiate ring-opening polymerization into polysilane, denoted [—Si(H₂)—]n. Presumably, some of the UV-initiated reactive species can permeate into pores of the host particles. The porous host particles containing polysilane in the pores can then be annealed at a higher temperature (e.g., 200-550° C.) for 0.5-4 hours to transform the polysilane into amorphous silicon coating or particles through the elimination of excess hydrogen. The particulates were then subjected to tube furnace annealing at an even higher temperature (e.g., >550° C.) for 0.5-3 hours in a nitrogen atmosphere to induce further desorption of hydrogen, followed by a higher temperature heat treatment at 800-1,200° C. for 0.5-2 h. High-energy radiation exposure, such as electron beam, X-ray, and Gama ray, may be used to replace or augment UV for Si deposition.

In general, the deposited Si coating or particles do not fully occupy the pores of a host particle, allowing a sufficient amount of voids to accommodate the volume expansion of Si during the battery charging procedure. Most preferably, the residual pore-to-Si volume ratio is from 0.5 to 5.0, further preferably from 1.0 to 4.0. The Si coating or Si particles preferably have a thickness or diameter from 2 nm to 1 μm, more preferably from 10 nm to 500 nm and further preferably from 20 nm to 150 nm.

It may be noted that presumably the same or a similar process or apparatus can be implemented to deposit a Si film onto an anode current collector (e.g., a Cu foil) to directly produce an anode (negative electrode). However, given a desirable or economically viable length of time, the deposited Si film tends to be too thin to have a high specific areal capacity (mAh/cm²). In contrast, the presently disclosed particulates are in a powder form that can be readily incorporated with an optional binder and optional conductive additive to form an anode (negative electrode) of high areal capacity, typically higher than 4.5 mAh/cm², more typically higher than 6 mAh/cm², further typically and desirably higher than 10 mAh/cm², still more typically and desirably higher than 20 mAh/cm², 30 mAh/cm², 50 mAh/cm², etc. These high areal capacities normally could not be achieved if one chooses to deposit pure Si directly on a current collector.

Another process for producing a solid powder mass of multiple anode material particulates for use in a sodium battery anode is based on an electrochemical method. The process comprises: (a) providing a working electrode comprising a solid powder mass comprising multiple porous host particles (e.g., carbonaceous, graphitic, graphene, and/or metallic particles) having a dimension from 50 nm to 50 μm (preferably from 100 nm to 30 μm and further preferably from 500 nm to 15 μm) and a volume fraction of pores from 5% to 99.9%; (b) dissolving or dispersing a source of a selected anode active material in a liquid electrolyte; (c) providing a counter electrode; and (d) disposing the working electrode, the liquid electrolyte, and the counter electrode in a first electrodeposition chamber and applying a desired current or voltage sequence across the working electrode and the counter electrode to electrodeposit an anode active material into the pores of the porous particles to obtain and recover the solid powder mass of separate or non-bonded multiple anode material particulates. These particulates are substantially separated from one another and are not bonded to one another. The pores inside the host particles are preferably interconnected to facilitate fast migration of anode active material atoms during the electrodeposition process. The volume fraction of pores is preferably from 30% to 95% and most preferably from 50% to 90%.

The anode active material is preferably selected from silicon (Si), germanium (Ge), tin (Sn), Phosphorus (P), lead (Pb), antimony (Sb), bismuth (Bi), aluminum (Al), titanium (Ti), or a combination thereof. The anode active material source preferably comprises a material selected from SiCl₄, GeCl₄, SnCl₄, SiBr₄, GeBr₄, SnBr₄, SiI₄, GeI₄, SnI₄, SiHCl₃, GeHCl₃, SnHCl₃, SiHBr₃, GeHBr₃, SnHBr₃, SiHI₃, GeHI₃, SnHI₃, or a salt of Si, Ge, Sn, P, Pb, Sb, Bi, Al, Ti, or a combination thereof.

The liquid electrolyte for use in this electrochemical process preferably contains a liquid selected from 1,3-dioxolane (DOL), 1,2-dimethoxyethane (DME), tetraethylene glycol dimethylether (TEGDME), poly(ethylene glycol)dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), tetrahydrofuran (THF), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, Hydrofluoro ether (HFE), Trifluoro propylene carbonate (FPC), Methyl nonafluorobutyl ether (MFE), Fluoroethylene carbonate (FEC), Tris(trimethylsilyl)phosphite (TTSPi), Triallyl phosphate (TAP), Ethylene sulfate (DTD), 1,3-propane sultone (PS), Propene sultone (PES), Alkylsiloxane (Si—O), Alkylsilane (Si—C), liquid oligomeric silaxane (—Si—O—Si—), Tetraethylene glycol dimethylether (TEGDME), canola oil, an ionic liquid, Tetramethylammonium chloride (TMACL), tetraethylammonium chloride (TEACL), tetrabutylammonium chloride (TBACL), tetrabutylammonium perchlorate (TBACLO), a tetraalkylammonium salt, or a combination thereof.

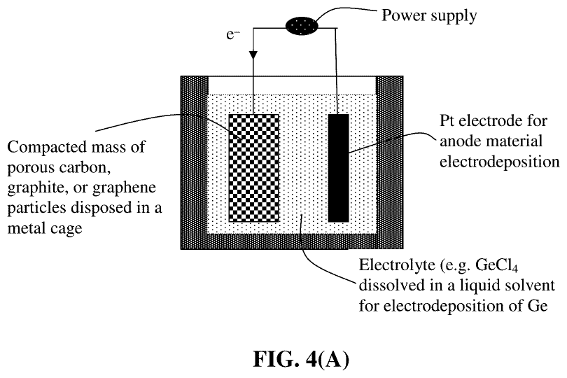

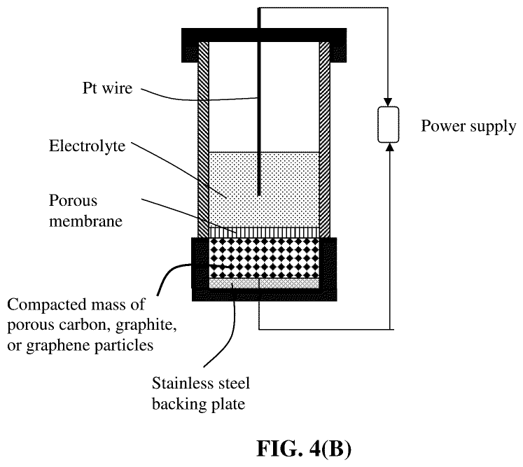

As an illustrative example, FIG. 4(A) or FIG. 4(B) schematically shows an apparatus that can be used to practice the presently disclosed process. Again, Si is used as an example. A preferred Si deposition process involves electro-chemically forcing Si atoms to migrate into the pores of multiple host particles (carbon/graphite/graphene particles) under the influence of an electromotive force (emf). In a typical arrangement, using activated carbon as an example, a compacted mass of activated carbon particles is used as a working electrode and noble metal (e.g., Pt wire, sheet or rod) as a counter electrode, possibly also serving as a reference electrode, if so desired. The two electrodes are then immersed in a liquid electrolyte (e.g., SiCl₄ or SiHCl₃ dissolved in PC). An electric current is then applied between the two electrodes. The two electrodes are subjected to a desired sequence of current/voltage profile. As an example, the silicon electrodeposition occurs with a cathodic peak around −3.4 V. The increase of cathodic current around −4.2 V (0.1 V vs Li/Li⁺), beyond the onset of silicon deposition, may induce decomposition of PC. The Si coating on pore walls may be achieved at a constant potential of −3.4 V or lower at a constant current density of 1-100 mA/cm² for 0.2-5 h.

This is similar to an electro-plating procedure, but, surprisingly, Si atoms are capable of permeating into the pores of the activated carbon particles (and porous graphitic or graphene particles). For electro-chemical deposition of Si into pores of the porous host particles, the particles may be confined in a porous container (e.g., fine metal mesh) that is permeable to electrolyte, but does not allow solid host particles (carbon/graphite/graphene particles) to escape. The fine metal mesh serves as a working electrode while a Pt wire as a counter electrode. The entire set-up is preferably immersed in a liquid electrolyte contained in an electrochemical reactor (a chamber).

Using SiCl₄ as a source of Si, presumably the following reactions occur on the working and counter electrodes, respectively:

SiCl₄+4e⁻→Si+4Cl⁻ (working electrode)

4Cl⁻→2Cl₂+4e⁻ (counter electrode).

It may be noted that presumably the same or a similar apparatus can be implemented to deposit Si onto an anode current collector (e.g., a Cu foil) to directly produce an anode (negative electrode). However, given a desirable or economically viable length of time, the deposited Si film tends to be too thin to have a high specific areal capacity (mAh/cm²). In contrast, the presently disclosed particulates are in a powder form that can be readily incorporated with an optional binder and optional conductive additive to form an anode (negative electrode) of high areal capacity, typically higher than 4.5 mAh/cm², more typically higher than 6 mAh/cm² further typically and desirably higher than 10 mAh/cm², still more typically and desirably higher than 20 mAh/cm², 30 mAh/cm², 50 mAh/cm², etc. These high areal capacities normally could not be achieved if one chooses to deposit pure Si directly on a current collector.

The porous host particles are preferably selected from carbonaceous, graphitic, graphene, or metallic particles. The preparation of porous metallic particles is well-known in the art. For instance, one may mix or alloy a metal element A (e.g., Sn) with a sacrificial element Z or ingredient of multi-elements to form particles of A-Z alloy or mixture. The element Z is then chemically etched away, leaving behind pores in the Sn particles.

The porous graphene particles preferably comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof. The production of these graphene materials is well-known in the art.

The porous carbonaceous or graphitic particles preferably comprise porous particles of activated carbon, soft carbon (defined as a carbon material that is graphitizable), hard carbon (carbon material not graphitizable even at a temperature higher than 2,500° C.), polymeric carbon, activated natural graphite, activated artificial graphite, exfoliated graphite worms, expanded graphite flakes, meso-phase carbon, needle coke, or a combination thereof.

In some embodiments, step (c) is followed by a procedure of pre-sodiating the multiple Si-containing anode material particulates, wherein the anode material (Si) is pre-sodiated to contain an amount of sodium from 1% to 100% of a maximum sodium content contained in said anode active material.

The anode active material (e.g., Si, Sn, and Ge) on the pore walls of porous host particles may be pre-sodiated before or after the anode fabrication, for the purpose of improving the first-cycle efficiency of a resulting sodium-ion cell. Pre-sodiation of anode active materials, such as Si, Ge, Sb, P, and Sn, can be accomplished in several different ways that can be classified into 3 categories: physical methods, electrochemical methods, and chemical methods. The chemical methods are typically conducted by sourcing sodium atoms from active reactants or sodium metal. The active reactants can include organometallic compounds and sodium salts and the reactions can be effectuated ex-situ (in a chemical reactor before anode fabrication, or after anode fabrication but before cell assembly). One may also bring sodium metal in direct contact with particles of the desired anode active material in a dry condition or with the presence of a liquid electrolyte.

A physical process entails depositing a Na coating on a surface of an anode active material substrate (e.g., surface of M-containing particulates), followed by promoting thermally induced diffusion of Na into the substrate (e.g., into the interior of a M particle/coating deposited on pore walls of host particles). A thin sodium layer can be deposited on the surface of an anode material substrate using a standard thin film process, such as thermal evaporation, electron beam evaporation, sputtering, and laser ablation. A vacuum is preferably used during the deposition process to avoid reactivity between the atomic sodium and molecules of sodium-reactive substances such as water, oxygen, and nitrogen. A vacuum of greater than 1 milli-Torr is desirable. When electron beam deposition is used a vacuum of 10⁻⁴ Torr is desired and a vacuum of 10⁻⁶ Torr is preferred to avoid interaction between the electron beam and any residual air molecules.

The evaporative deposition techniques involve the heating of a sodium metal to create a sodium vapor. The sodium metal can be heated by an electron beam or by resistive heating of the sodium metal. The sodium vapor deposits sodium onto a substrate composed of packed Si-containing particles. To promote the deposition of sodium metal the substrate can be cooled or maintained at a temperature lower than the temperature of the sodium vapor. A thickness monitor such as a quartz crystal type monitor can be placed near the substrate to monitor the thickness of the film being deposited. Alternatively, laser ablation and sputtering techniques can be used to promote thin sodium film growth on a substrate. For example, argon ions can be used in the sputtering process to bombard a solid sodium metal target. The bombarding knocks sodium off of the target and deposits it on the surface of a substrate. Laser ablation processes can be used to knock sodium off of a sodium target. The separated sodium atoms are then deposited onto the substrate. The sodium-coated layer of packed Si-containing particles is then immersed into a liquid electrolyte containing a sodium salt dissolved in an organic solvent. Sodium atoms rapidly permeate into the bulk of Si particles to form prelithiated Si particles. Physical methods may also be conducted by simply mixing molten sodium metal with the anode particulates.

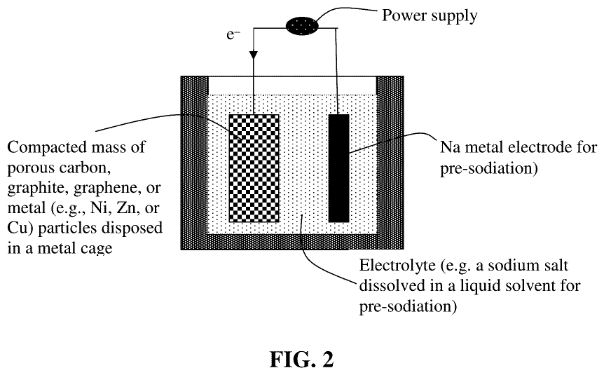

A more preferred pre-sodiation process involves electro-chemically forcing Na atoms to migrate into M particle/coating under the influence of an electromotive force (emf). In a typical arrangement, again using Si as an example, a compacted mass of Si-containing porous particulates is used as a positive electrode and Na metal sheet or rod as a negative electrode, in a chamber similar to what is illustrated in FIG. 2. The two electrodes are then immersed in a liquid electrolyte containing a sodium salt dissolved in an organic solvent. An electric current is then applied between the anode and the cathode. This is similar to an electro-plating procedure, but, surprisingly, Na atoms are capable of permeating into the bulk of the Si particle/coating. For electro-chemical sodiation of Si, the Si-containing porous particulates may be confined in a porous container (e.g., fine metal mesh) that is permeable to electrolyte, but does not allow solid Si-containing particulates to escape. The fine metal mesh serves as a working electrode while a sodium metal rod or sheet serves as a counter electrode. The entire set-up is preferably immersed in a liquid electrolyte contained in an electrochemical reactor.

Preferably, the sodium salt in the liquid electrolyte is selected from sodium perchlorate (LiClO₄), sodium hexafluorophosphate (LiPF₆), sodium borofluoride (LiBF₄), sodium hexafluoroarsenide (LiAsF₆), sodium trifluoro-metasulfonate (LiCF₃SO₃), bis-trifluoromethyl sulfonylimide sodium (LiN(CF₃SO₂)₂), sodium bis(oxalato)borate (LiBOB), sodium oxalyldifluoroborate (LiBF₂C₂O₄), sodium oxalyldifluoroborate (LiBF₂C₂O₄), sodium nitrate (LiNO₃), Li-Fluoroalkyl-Phosphates (LiPF₃(CF₂CF₃)₃), sodium bisperfluoro-ethysulfonylimide (LiBETI), sodium bis(trifluoromethanesulphonyl)imide, sodium bis(fluorosulphonyl)imide, sodium trifluoromethanesulfonimide (LiTFSI), or a combination thereof. It may be noted that these metal salts are also commonly used in the electrolytes of rechargeable sodium batteries.

The electrolytes used in this electrochemical reactor may contain a solvent selected from 1,3-dioxolane (DOL), 1,2-dimethoxyethane (DME), tetraethylene glycol dimethylether (TEGDME), poly(ethylene glycol)dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof. These solvents are also commonly used in the electrolytes of rechargeable sodium batteries.

The pre-sodiated anode active material particles may be subsequently subjected to a surface treatment that produces a surface-stabilizing coating to embrace the pre-sodiated particles, wherein this surface-stabilizing coating is a layer of sodium- or sodium-containing species that are chemically bonded to the pre-sodiated particles.

These bonding species (sodium- or sodium-containing species) can be simply generated as the products or by-products of select chemical or electrochemical reactions between the electrolyte (Na salt dissolved in a solvent) and the anode active material particle surfaces (where elements such as C, O, H, and N are often present or prescribed to exist). These reactions may be preferably induced by externally applied current/voltage in an electrochemical reactor. This will be discussed in more detail later. The following procedure for producing surface stabilizing species is applicable to both pre-sodiated and non-sodiated particles of an anode active material. There is no limitation on the type of anode materials; all types of anode active materials that can be used in a sodium battery anode can be protected or embraced by using this invented method.

In a preferred embodiment, the sodium- or sodium-containing species may be selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, or a combination thereof, wherein X═F, Cl, I, or Br, R=a hydrocarbon group (e.g. R═CH—, CH₂—, CH₃CH₂—, etc.), x=0-1, y=1-4. These species are surprisingly capable of chemically bonding to surfaces of various anode active material particles to form a structurally sound encapsulating layer. Such a layer is also permeable to sodium ions, enabling subsequent sodium intercalation/insertion and de-intercalation/extraction into/from the protected particles. Typically, not just one, but at least two types of sodium- or sodium-containing species in the above list are present in the protective layer embracing the prelithiated or non-lithiated particles if this layer is produced electrochemically.

The preparation of the surface-protecting layers containing these sodium- or sodium-containing species may be conducted in an electrochemical reactor, which is an apparatus very similar to an electrode plating system. In this reactor, an anode material-containing porous structure (in the form of a mat, paper, film, etc. or simply in a compacted mass confined by a mess of conducting wires) is used as a working electrode and sodium sheet (or sodium sheet) as a counter electrode. Contained in the reactor is an electrolyte composed of a sodium or sodium salt dissolved in a solvent (e.g. 1 M NaPF₆ dissolved in a mixture of ethylene carbonate (EC) and dimethyl carbonate (DMC) at a 1:1 ratio by volume). A current is then imposed between these two electrodes (sodium or sodium sheet electrode and the anode active material-based working electrode). The particles of the anode active material in the working electrode are galvanostatically discharged (e.g. Na ions being sent to and inserted into the anode active material particles) and charged (Na ions released by these particles) in the voltage range from 0.01V to 4.5V at the current densities of 100-1000 mA/g following a voltage-current program similar to what would be used in a sodium-ion battery. However, the system is intentionally subjected to conditions conducive to oxidative degradation of electrolyte (e.g. close to 0.01-1.0 V vs. Na/Na⁺) or reductive degradation of electrolyte (4.1-4.5 V vs. Na/Na⁺) for a sufficient length of time. The degradation products react with Na⁺ ions, Na salt, functional groups (if any) or carbon atoms coated on particles to form the sodium-containing species that also chemically bond to the particles.

The chemical compositions of the sodium-containing species are governed by the voltage range, the number of cycles (from 0.01 V to 4.5 V, and back), solvent type, sodium salt type, chemical composition of graphene sheets (e.g., % of 0, H, and N), and electrolyte additives (e.g. NaNO₃, if available). The morphology, structure and composition of graphene oxide (GO), reduced graphene oxide (RGO), the sodium-containing species that are bonded to graphene sheets can be characterized by scanning electron microscope (SEM), transmission electron microscope (TEM), Raman spectrum, X-ray diffraction (XRD), Fourier Transform Infrared Spectroscopy (FTIR), elemental analysis, and X-ray photoelectron spectroscopy (XPS).

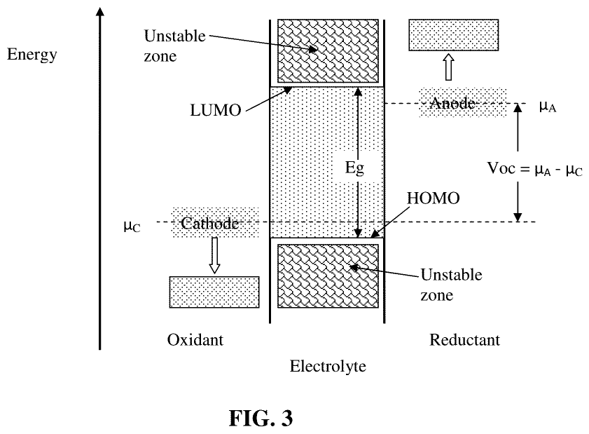

The decomposition of non-aqueous electrolyte leads to the formation of sodium or sodium chemical compounds that bond to graphene surfaces and edges. The reasons why the non-aqueous electrolyte decomposed during discharge-charge cycling in an electrochemical reactor may be explained as follows. As illustrated in FIG. 3, in an electrochemical reactor system where there are a cathode and an anode in contact with an electrolyte, the thermodynamic stability of the electrolyte is dictated by the relative electron energies of the two electrodes relative to the energy level of the non-aqueous electrolyte. The anode is potentially a reductant, and the cathode an oxidant. The two electrodes are typically electronic conductors and, in this diagram, their electrochemical potential are designated as μ_{A} and μ_{C} (or Fermi energies ε_{F}), respectively. The energy separation, E_{g}, between the lowest unoccupied molecular orbital (LUMO) and the highest occupied molecular orbital (HOMO) of the electrolyte is the stable electrochemical window of the electrolyte. In other words, in order for the electrolyte to remain thermodynamically stable (i.e. not to decompose), the electrochemical potential of the anode (μ_{A}) should be maintained below the LOMO and pc of the cathode should be above the HOMO.

From the schematic diagram of FIG. 3, we can see that an anode with μ_{A} above the LUMO and a cathode with pc below the HOMO will reduce and oxidize the electrolyte, respectively, unless a passivating film is formed that creates a barrier to electron transfer between the anode and the electrolyte or between the cathode and the electrolyte. In the presently invented method, an external current/voltage is intentionally applied over the anode and the cathode to bias their respective electrochemical potential levels so that the electrolyte can go outside of the stable electrochemical potential window, undergoing oxidative and/or reductive degradation. The degradation products are reactive species that react among themselves and with the functional groups or active atoms on particles of the anode active material or their surface coverage layer (carbon, graphene, conductive polymers, etc.), forming a mass of sodium- or sodium-containing species that bond to surfaces of these particles (with or without a surface coverage.

For the list of sodium/sodium salts and solvents investigated, the electrolytes have an oxidation potential (HOMO) at about 4.7 V and a reduction potential (LUMO) near 1.0 V. (All voltages in this specification are with respect to Li⁺/Li or Na⁺/Na). We have observed that the chemical interaction of Li⁺ or Na⁺ ions with particles of an anode active material (with or without carbon or graphene coverage) typically occur at about 0.01-0.8 V, so electrolytes are prone to reductive degradation in the voltage range of 0.01-0.8 V. By imposing a voltage close to 4.7 volts, the electrolytes are also subject to oxidative degradation. The degradation products spontaneously react with chemical species associated with these particles, forming a protective layer embracing/encapsulating these particles during the charge-discharge cycling (electrolyte reduction-oxidation cycling). In general, these sodium- or sodium-containing species are not electrically conducting and, hence, these reactions can self-terminate to form essentially a passivating phase.

The electrolytes that can be used in this electrochemical decomposition reactor may be selected from any sodium metal salt that is dissolvable in a solvent to produce an electrolyte. Some lithium salts or potassium salts may also be used. Preferably, the metal salt may be selected from sodium perchlorate (LiClO₄), sodium hexafluorophosphate (LiPF₆), sodium borofluoride (LiBF₄), sodium hexafluoroarsenide (LiAsF₆), sodium trifluoro-metasulfonate (LiCF₃SO₃), bis-trifluoromethyl sulfonylimide sodium (LiN(CF₃SO₂)₂), sodium bis(oxalato)borate (LiBOB), sodium oxalyldifluoroborate (LiBF₂C₂O₄), sodium oxalyldifluoroborate (LiBF₂C₂O₄), sodium nitrate (LiNO₃), Li-Fluoroalkyl-Phosphates (LiPF₃(CF₂CF₃)₃), sodium bisperfluoro-ethysulfonylimide (LiBETI), sodium bis(trifluoromethanesulphonyl)imide, sodium bis(fluorosulphonyl)imide, sodium trifluoromethanesulfonimide (LiTFSI), sodium perchlorate (NaClO₄), sodium hexafluorophosphate (NaPF₆), sodium borofluoride (NaBF₄), sodium trifluoro-metasulfonate (NaCF₃SO₃), bis-trifluoromethyl sulfonylimide sodium (NaN(CF₃SO₂)₂), sodium trifluoromethanesulfonimide (NaTFSI), bis-trifluoromethyl sulfonylimide sodium (NaN(CF₃SO₂)₂), or a combination thereof. It may be noted that these metal salts are also commonly used in the electrolytes of rechargeable sodium or sodium batteries.

The electrolytes used in this electrochemical decomposition reactor may contain a solvent selected from 1,3-dioxolane (DOL), 1,2-dimethoxyethane (DME), tetraethylene glycol dimethylether (TEGDME), poly(ethylene glycol)dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof. These solvents are also commonly used in the electrolytes of rechargeable sodium or sodium batteries.

The electrochemical decomposition reactor used for the formation of a surface protection layer may be the same electrochemical reactor for pre-sodiation. As illustrated in FIG. 2, the pre-sodiation process may be allowed to proceed at a current/voltage condition that is in favor of electrochemically inserting sodium ions into the anode active material particles (this condition being in the thermodynamic stability regions depicted in FIG. 3). For example, the voltage difference between the working electrode (containing Si particles, for instance) and the counter electrode may be cycled between 0.6 volts and 3.3 volts for pre-sodiation of Si. Following this pre-sodiation procedure, the voltage difference is then cycled between 0.1 volts and 4.5 volts (as an example) to effectuate electrochemical decomposition of the electrode for forming the Li- and/or Na-containing species. The electrolyte used in pre-sodiation can be the same as or different than the electrolyte used for protective species formation.

The protective layer of the instant invention typically exhibits a sodium ion conductivity from 2.5×10⁻⁵ S/cm to 5.5×10⁻³ S/cm, and more typically from 1.0×10⁻⁴ S/cm to 2.5×10⁻³ S/cm. The anode active material may be made into a thin film and then the Li- or Na-containing species are coated thereon and then peeled off to allow for ion conductivity measurement.

Several micro-encapsulation processes can be used to embrace/encapsulate particles of an anode active material (with or without pre-sodiation) with a protective layer. This preferably requires dissolution of a sodium salt or multiple sodium salts in a solvent (including mixture of multiple solvents) to form a solution. This solution can then be used to encapsulate solid particles via several of the micro-encapsulation methods to be discussed in what follows. The same type of encapsulation processes may be used to encapsulate the disclosed porous conducting host particles containing an anode active material deposited therein, with or without pre-sodiation.

There are three broad categories of micro-encapsulation methods that can be implemented to produce encapsulated particles of an anode active material: physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation or other surface reactions. Several methods are discussed below as examples.

Pan-coating method: The pan coating process involves tumbling the active material particles in a pan or a similar device while the encapsulating material (e.g. highly concentrated solution of Li/Na salts in a solvent) is applied slowly until a desired encapsulating shell thickness is attained.

Air-suspension coating method: In the air suspension coating process, the solid particles (core material) are dispersed into the supporting air stream in an encapsulating chamber. A controlled stream of a salt-solvent solution (with an optional polymer) is concurrently introduced into this chamber, allowing the solution to hit and coat the suspended particles. These suspended particles are encapsulated (fully coated) with the salts while the volatile solvent is removed, leaving a very thin layer of Li and/or Na salts on surfaces of these particles. This process may be repeated several times until the required parameters, such as full-coating thickness (i.e. encapsulating shell or wall thickness), are achieved. The air stream which supports the particles also helps to dry them, and the rate of drying is directly proportional to the temperature of the air stream, which can be adjusted for optimized shell thickness.

In a preferred mode, the particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating shell thickness is achieved.

Centrifugal extrusion: Anode active materials may be encapsulated using a rotating extrusion head containing concentric nozzles. In this process, a stream of core fluid (slurry containing particles of an anode active material dispersed in a solvent) is surrounded by a sheath of shell solution or melt. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle method: Core-shell encapsulation of an anode active material can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the anode active material. The solidification can be done according to the used gelation system with an internal gelation (e.g. sol-gel processing, melt) or an external (additional binder system, e.g. in a slurry).

Spray-drying: Spray drying may be used to encapsulate particles of an active material when the active material is dissolved or suspended in a melt or polymer solution. In spray drying, the liquid feed (solution or suspension) is atomized to form droplets which, upon contacts with hot gas, allow solvent to get vaporized and thin polymer shell to fully embrace the solid particles of the active material.

It may be noted that the anode active material (e.g., prelithiated or non-lithiated particulates) may be coated with a carbonizable coating material (e.g., phenolic resin, poly(furfuryl alcohol), coal tar pitch, or petroleum pitch). The coating can then be carbonized to produce an amorphous carbon or polymeric carbon coating on the surface of these particulates. Such a conductive surface coating can help maintain a network of electron-conducting paths during repeated charge/discharge cycles and prevent undesirable chemical reactions between Si and electrolyte from happening. Hence, the presently invented method may further comprise a step of coating a surface of the particulates with a thin layer of carbon having a thickness less than 1 μm. The thin layer of carbon preferably has a thickness less than 100 nm. Such a thin layer of carbon may be obtained from pyrolization of a polymer, pitch, or organic precursor or obtained by chemical vapor deposition, physical vapor deposition, sputtering, etc.

Alternatively, the particulates containing an anode active material therein may be coated with a layer of electron-conducting polymer or ion-conducting polymer. Such coating processes are well-known in the art.

The surface-stabilized or surface-stabilized and prelithiated particles of an anode active material (with or without a coating of carbon, graphene, electron-conducting polymer, or ion-conducting polymer) may be further encapsulated by a thin layer of a high-elasticity polymer (e.g. an elastomer) having a fully recoverable tensile strain of from 5% to 700% and a thickness preferably from 0.5 nm to 2 μm (preferably from 1 nm to 100 nm). The elastomer preferably has a sodium ion conductivity from 10⁻⁷ S/cm to 5×10⁻² S/cm at room temperature (preferably and typically no less than 10⁻⁶ S/cm, further preferably no less than 10⁻⁵ S/cm, more preferably no less than 10⁻⁴ S/cm, and most preferably no less than 10⁻³ S/cm).

In others, the elastomeric material is an elastomer matrix composite containing from 0.1% to 50% by weight (preferably from 1% to 35% by weight) of a sodium ion-conducting additive dispersed in an elastomer matrix material.

In some embodiments, the elastomeric material contains a material selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including acrylate butyl rubbers, halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually includes two types of domains, soft domains and hard ones. Entangled linear backbone chains including of poly(tetramethylene ether)glycol (PTMEG) units constitute the soft domains, while repeated methylene diphenyl diisocyanate (MDI) and ethylene diamine (EDA) units constitute the hard domains. The sodium ion-conducting additive can be incorporated in the soft domains or other more amorphous zones.

In some embodiments, the elastomeric material is an elastomer matrix composite containing a sodium ion-conducting additive dispersed in an elastomer matrix material, wherein said sodium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

In some embodiments, the elastomeric material is an elastomer matrix composite containing a sodium ion-conducting additive dispersed in an elastomer matrix material, wherein said sodium ion-conducting additive contains a sodium salt selected from sodium perchlorate, NaClO₄, sodium hexafluorophosphate, NaPF₆, sodium borofluoride, NaBF₄, sodium hexafluoroarsenide, NaAsF₆, sodium trifluoro-metasulfonate, NaCF₃SO₃, bis-trifluoromethyl sulfonylimide sodium, NaN(CF₃SO₂)₂, sodium bis(oxalato)borate, NaBOB, sodium oxalyldifluoroborate, NaBF₂C₂O₄, sodium oxalyldifluoroborate, NaBF₂C₂O₄, sodium nitrate, NaNO₃, Na-Fluoroalkyl-Phosphates, NaPF₃(CF₂CF₃)₃, sodium bisperfluoro-ethysulfonylimide, NaBETI, sodium bis(trifluoromethanesulphonyl)imide, sodium bis(fluorosulphonyl)imide, sodium trifluoromethanesulfonimide, NaTFSI, an ionic liquid-based sodium salt, or a combination thereof.

The elastomeric material may contain a mixture or blend of an elastomer and an electron-conducting polymer selected from polyaniline, polypyrrole, polythiophene, polyfuran, a bi-cyclic polymer, derivatives thereof (e.g. sulfonated versions), or a combination thereof.

In some embodiments, the elastomeric material contains a mixture or blend of an elastomer and a sodium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a derivative thereof (e.g. sulfonated versions), or a combination thereof.

In the preparation of an anode electrode, acetylene black (AB), carbon black (CB), or ultra-fine graphite particles may be used as a conductive additive. Conductive additives may comprise an electrically conductive material selected from the group consisting of electro-spun nano fibers, carbonized electro-spun nano fibers, vapor-grown carbon or graphite nano fibers, carbon or graphite whiskers, carbon nano-tubes, nano-scaled graphene platelets, metal nano wires, metal-coated nano wires, carbon-coated nano wires, metal-coated nano fibers, carbon-coated nano fibers, and combinations thereof. A binder material may be chosen from polytetrafluoroethylene (PTFE), polyvinylidene fluoride (PVDF), ethylene-propylene-diene copolymer (EPDM), or styrene-butadiene rubber (SBR), for example. Conductive materials such as electronically conductive polymers, meso-phase pitch, coal tar pitch, and petroleum pitch may also be used as a binder. A typical mixing ratio of these ingredients is 80 to 85% by weight for the anode active material, 5 to 15% by weight for the conductive additive, and 5 to 10% by weight for the binder. The current collector may be selected from aluminum foil, stainless steel foil, and nickel foil. There is no particularly significant restriction on the type of current collector, provided the material is a good electrical conductor and relatively corrosion resistant. The separator may be selected from a polymeric nonwoven fabric, porous polyethylene film, porous polypropylene film, or porous PTFE film.

The electrode fabrication may comprise combining multiple porous conductive particles (containing solution-deposited Si, with or without pre-sodiation) with a conductive additive and/or a binder material and, in certain embodiments, plus a desired amount of another type of anode active materials selected from particles of graphite, hard carbon, soft carbon, meso-carbon micro-bead, surface-modified graphite, carbon-coated graphite, or a combination thereof.

Hence, a sodium ion battery may contain an anode that comprises one or at least two types of anode active material wherein at least one type of active material is presodiated (e.g., Si and Sn) and at least one type of active material is not presodiated (e.g., carbonaceous material, such as graphite, hard carbon, soft carbon, surface-modified graphite, chemically modified graphite, or meso-carbon micro-beads, MCMBs). Presodiated carbonaceous anode materials are unstable in regular room air. The present invention enables the battery to contain an anode that comprises at least a non-carbon active material possessing an ultra-high sodium absorbing capacity. The battery comprises an anode that contains an excess amount of sodium (disposed inside a non-carbon anode active material, not on its surface) to compensate for the formation of SEI layers, in addition to providing enough sodium to intercalate into (or form a compound with) a cathode active material.

The present invention allows the excess amount of sodium to be stored in high-capacity anode active materials (there is no need to make use of the full capacity of Si, for instance). The capacity limitation is on the cathode side, rather than the anode side. The present approach obviates the need for the cathode to supply the needed sodium, thereby further reducing the needed initial weight of the cathode or increasing the cathode weight that can be incorporated in a cell. This strategy can increase the overall capacity of a sodium ion battery by another 10%-20%.

There is no particular restriction on the type of cathode active material that can be implemented in the cathode of the presently disclosed sodium-ion cell. In certain embodiments, the cathode comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ—MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

The cathode may comprise a cathode active material selected from a Na-based layered oxide (e.g., O3-type, P2-type, or P3-type), a polyanionic compound, a mixed polyanionic compound, a sulfate, a pyrophosphate, a Prussian Blue analog, or a combination thereof. In some specific embodiments, the cathode comprises a cathode active material selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

The electrolyte in a sodium-ion cell may comprise a sodium salt and a solvent selected from 1,3-dioxolane (DOL), 1,2-dimethoxyethane (DME), tetraethylene glycol dimethylether (TEGDME), poly(ethylene glycol)dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof.

The electrolyte may, in addition to the selected sodium salt, further comprise an alkali metal salt selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid-based lithium salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), and bis-trifluoromethyl sulfonylimide potassium (KN(CF₃SO₂)₂), or a combination thereof.

The content of aforementioned electrolytic salts in the non-aqueous solvent is preferably 0.5 to 3.0 M (mol/L) at the cathode side and 2.0 M to >10 M at the anode side.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane)sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl)imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3} results in RTILs with good working conductivities.

### Example 1: Production of Porous Graphene Particles (Graphene Balls) from Flake Graphite and Si Deposition from Cyclohexasilane in the Pores of Graphene Balls

In a representative procedure, 1 kg of polypropylene (PP) pellets, 50 grams of flake graphite, 50 mesh (average particle size 0.18 mm; Asbury Carbons, Asbury NJ) and 250 grams of magnetic steel balls were placed in a high-energy ball mill container. The ball mill was operated at 300 rpm for 2 hours. The container lid was removed and stainless steel balls were removed via a magnet. The polymer carrier material was found to be coated with a dark graphene layer. Carrier material was placed over a 50 mesh sieve and a small amount of unprocessed flake graphite was removed.

A sample of the coated carrier material was then submitted to air flow suspension in a heating chamber, wherein the graphene-coated PP particles were heat-treated at 350° C. and then at 600° C. for 2 hours to produce individual (isolated/separated) graphene balls.

In a separate experiment, the same batch of PP pellets and flake graphite particles (without the impacting steel balls) were placed in the same high-energy ball mill container and the ball mill was operated under the same conditions for the same period of time. The results were compared with those obtained from impacting ball-assisted operation. The graphene sheets isolated from PP particles, upon PP dissolution, are mostly single-layer graphene. The graphene balls produced from this process typically have a higher level of porosity (lower physical density).

After the porous graphene balls were prepared, they were impregnated with a liquid silane, cyclohexasilane (CHS, Si₆H₁₂), which maintains a low vapor pressure and is stable in ambient light. CHS is herein used for the solution-based synthesis of functional Si coating or particles in the pores. The CHS undergoes a ring-opening polymerization when exposed to heat or UV light, with thermal annealing transforming the polyhydrosilane to silicon. In the present study, porous graphene balls were immersed in liquid silane (CHS) at room temperature under simultaneous UV irradiation from a 500 W HgXe lamp to initiate ring-opening polymerization into polysilane, denoted [—Si(H₂)—]n. Presumably, some of the UV-initiated reactive species permeated into pores of the graphene balls. The porous graphene balls containing polysilane in the pores were then annealed at 400° C. for 1 h in a vacuum oven to transform the polysilane into amorphous silicon coating or particles through the elimination of excess hydrogen. The particulates were then subjected to tube furnace annealing at 550° C. for 1 h in a nitrogen atmosphere to induce further desorption of hydrogen, followed by a higher temperature heat treatment at 950° C. for 1 h.

### Example 2: Production of Activated Carbon by Chemical Activation of MCMBs by ZnCl₂, Followed by Electrodeposition of Ge in the Pores

We used two different amounts of starting material (400 g and 100 g). Other than this difference in starting amounts, all other variables were the same in the following activation procedures. The particles were impregnated with zinc chloride (ZnCl₂) at 1:1 wt. ratio and were kept at 80° C. for 14 h. Heat treatments were then carried out under constant nitrogen flow (5 l/h). The heat treatment temperature was raised at 4° C./min up to 500° C., which was maintained for 3 h. The samples were then washed to remove excess reagent and dried at 110° C. for about 3 h. The resulting samples were labeled as CA (chemically activated only). Part of these samples was then also submitted to physical activation. Temperature was raised to 900° C. at a rate of 25° C./min, under nitrogen flow. At 900° C., the samples were then contacted with steam (0.8 kg/h) for 30 min. These samples were then labeled as CAPA (both chemically and physically activated). It was observed that combined physical and chemical activation treatments led to a higher porosity level and slightly higher pore sizes that are more readily accessible to liquid electrolyte.

Propylene carbonate (PC) was selected as the solvent for GeCl₄ because of its high dielectric constant (k=64) and hence presenting a good environment for solubilizing the halide salts of germanium or silicon. To improve the ionic conductivity of the electrolyte, tetrabutyl ammonium chloride (TBACL, >97%), dried overnight at 100° C. in vacuum, was added as a supporting electrolyte to the solvent.

In a typical Ge deposition procedure, the electrolyte comprised of 0.5 M GeCl₄ (or GeHCl₃) and 0.1 M TBACL dissolved in PC. All the deposition procedures were carried out in a cylindrical three electrode cell made of glass, sealed with Teflon gaskets. Copper wire cage containing porous activated carbon particles trapped therein was used as the working electrode, platinum wire (diameter=0.5 mm, 99.95%) and platinum foil (0.1 mm thick, 0.5 cm×0.5 cm, 99.9%, Aldrich) served as the reference and counter electrodes, respectively. The electrodes were sonicated in ethanol and acetone for 5 min and dried in air before use. Voltammetric studies such as linear sweep voltammetry (LSV) and chronopotentiometry were conducted using a potentiostat. After Ge deposition, the porous AC particles containing Ge coating therein were subjected to an electrochemical pre-sodiation treatment using a similar apparatus, but the liquid electrolyte was replaced by a 1 M NaClO₄ dissolved in ethylene carbonate and the Pt wire replaced by a piece of Na foil.

### Example 3: Deposition of Si in the Pores of Activated Carbon (AC)

For the study on the deposition of Si in the pores of the AC particles prepared in Example 2, the following chemicals were used: Bis[bis(trimethylsilyl)amino]tin(II) (Sn(hmds)₂), trisilane (Si₃H₈), isotetrasilane (Si₄H₁₀), neopentasilane (Si₅H₁₂), dodecylamine, squalane, and poly(vinylpyrrolidinone)-hexadecane (PVP-HDE) copolymer. PVP-HDE was dissolved in dodecylamine to make a 33% w/w copolymer solution. The copolymer solution and the squalane were degassed under vacuum at 80° C. for 45 min and then stored in a nitrogen-filled glovebox prior to use.

Si deposition in the pores was carried out using a Sn-seeded Si nanorod growth reaction. The reactions were carried out on a Schlenk line setup operated inside a nitrogen-filled glovebox. In a typical reaction, 10 mL of squalane was heated to 380° C. under N₂ flow in a flat bottom flask attached to the Schlenk line assembly.

Separately, a precursor solution of 1 mL of PVP-HDE/dodecylamine solution (containing 27.5 mg of PVP-HDE), 20 μL of Sn(hmds)₂, and 76 μL of trisilane was prepared in a vial at room temperature, which immediately turned dark brown after mixing due to the formation of Sn nanoparticles. A small amount of AC particles were immersed in the precursor solution during the mixing procedure. The mixture was then poured into the hot solvent. After 3 min, the reaction flask was removed from the heating mantle and allowed to cool to room temperature.

In two additional, separate reactions, the precursor solutions were made of 70 μL of isotetrasilane, 68 μL of neopentasilane, and 56 μL of cyclohexasilane, respectively, to maintain a consistent [Si] concentration in each reaction. Reaction temperatures ranging between 180° and 380° C. were used.

### Example 4: Synthesis of Porous Carbon/Tin Composite Nanoparticles

The synthesis of the porous C/Sn composite materials included of three steps: preparation of polymer solution, SnO₂ nanoparticle dispersion, and carbonization. All materials were purchased from Sigma-Aldrich and were used without further purification. In one example, the polymer solution was prepared by dissolving 0.33 g resorcinol (R), 0.22 g triblock copolymer (Pluronic F127) and 1 ml 1% NaOH aqueous solution in 5 ml N,N-dimethylformamide (DMF), where the triblock copolymer and the NaOH functioned as the soft-template and catalyst, respectively. When the solution was clear, 0.4 g 37% formaldehyde (F) aqueous solution was added. After 30 min vigorous stirring, the solution was stirred for another 30 min at 80° C. to promote the polymerization reaction between resorcinol and formaldehyde. In the meantime, 0.5 g SnO₂ nanoparticles (<100 nm) were dispersed into 30 ml DMF by ultrasonication. Then the obtained solution was added into the dispersion and underwent ultrasonic treatment. The mixture was dried while stirring at 100° C. overnight and was further cured in an oven at 100° C. for 24 h. Finally, the polymer/SnO₂ composite was carbonized with a heating rate of 2° C./min in flowing argon at 400° C. for 3 h and then at 700° C. for an additional 3 h. SnO₂ was reduced to Sn metal in the presence of carbon during the carbonization process. In a separate experiment, this reduction reaction was conducted to form Sn coating inside the pores of AC particles.

### Example 5: Production of Graphene Balls from Flake Graphite and Si Electrodeposition

After the porous graphene balls were prepared in Example 1, some of these porous balls were immersed in a solution of silicon tetrachloride dissolved in propylene carbonate (PC) using 0.5 M TBACl (tetrabutyl ammonium chloride) as a supporting electrolyte. The electrodes, comprising compacted graphene balls, were placed as part of the working electrode so as to deposit silicon on the pore walls of porous particles in the working electrode with evolution of chlorine on the counter electrode. The silicon electrodeposition was found to occur with a cathodic peak around −3.4 V. The increase of cathodic current around −4.2 V (0.1 V vs Li/Li⁺), beyond the onset of silicon deposition, has been attributed to decomposition of PC and supporting electrolyte cations. As an illustrative example, the Si coating was deposited at a constant potential of −3.4 V at a constant current density of approximately 10 mA/cm² for 2 h.

### Example 6: Electrodeposition of Sn in the Pores of Activated Carbon Particles

For the electrochemical deposition of Sn in the pores, compacted porous MCMB particles were used as a working electrode and tin tetrachloride dissolved in propylene carbonate (PC) as the electrolyte; 0.5 M TBACl (tetrabutyl ammonium chloride) was used as a supporting electrolyte. Subsequently, electrochemical sodiation of the Sn coating was conducted according to a step involving an apparatus as schematically shown in FIG. 2. The electrodes were made of these porous, pre-sodiated particles, mixed with 5 wt % Super-P® and 7 wt % polytetrafluoroethylene (PTFE) binder. The procedure of slurry coating on Cu foil was conducted to produce electrodes having a thickness from 50 μm to 400 μm.

### Example 7: Electrodeposition of Bi in the Pores of Porous Carbon Particles

An electroless deposition solution of bismuth was prepared as follows. A solution of 0.1 M bismuth chloride in ethylene glycol was prepared by addition of the bismuth chloride to the solvent. The solution was formed at 80° C. with stirring until the solution was clear, Porous carbon particles were then immersed for 15 minutes in the stagnant electroless deposition solution maintained at 80° C. The carbon particles were then removed from the solution and washed of the solution in acetone and were allowed to dry in air. The color appearance of the carbon particles was found to change to lustrous silver. The Bi deposition was confirmed using various techniques including scanning electron microscopy (SEM).

1. A sodium battery containing an anode, a cathode, and an electrolyte in ionic contact with the anode and the cathode, wherein the anode comprises multiple M-containing porous particulates, where M is an element selected from Si, Ge, Sn, Sb, Pb, P, Bi, an alloy thereof, a compound thereof, or a combination thereof, and at least one of the porous particulates comprises (i) a porous host particle having pores and pore walls, wherein the porous host particle is electrically conducting having an electrical conductivity of no less than 10⁻⁶ S/cm;
and (ii) one or a plurality of M particles residing in said pores or M coating deposited on said pore walls; wherein the pores have a pore volume fraction from 5% to 99.9% of the host particle without the presence of M or prior to deposition of M in the host particle and an empty or unoccupied pore volume having an unoccupied pore volume-to-M volume ratio from 1/100 to 4/1 with the presence of M after deposition of M in the pores of the host particle.

2. The sodium battery of claim 1, wherein the porous host particles are selected from porous carbonaceous, graphitic, graphene, or metallic particles.

3. The sodium battery of claim 1, wherein said M-containing porous particulates contain a residual pore-to-M volume ratio from 0.5 to 3.0.

4. The sodium battery of claim 1, wherein said M coating or M particles have a thickness or diameter from 1 nm to 1 μm.

5. The sodium battery of claim 2, wherein said porous graphene particles comprise graphene sheets selected from pristine graphene, graphene fluoride, graphene chloride, graphene bromide, graphene iodide, nitrogenated graphene, hydrogenated graphene, doped graphene, chemically functionalized graphene, graphene oxide, reduced graphene oxide, or a combination thereof.

6. The sodium battery of claim 2, wherein said porous carbonaceous or graphitic particles comprise particles of activated carbon, soft carbon, hard carbon, polymeric carbon, activated natural graphite, activated artificial graphite, exfoliated graphite worms, expanded graphite flakes, meso-phase carbon, needle coke, or a combination thereof.

7. The sodium battery of claim 2, wherein said host metallic particles comprises a metal selected from a transition metal, Al, Ga, In, Sn, Bi, an alloy thereof, or a combination thereof.

8. The sodium battery of claim 1, wherein the porous particulates further comprise a thin protecting layer having a thickness from 0.5 nm to 2 μm and encapsulating or coating on the porous particulates and wherein the protecting layer comprises carbon, graphene, electron-conducting polymer, sodium ion-conducting polymer, or a combination thereof.

9. The sodium battery of claim 1, wherein the Si particles or coating in the porous particulates are preloaded with an element selected from Li, Na, K, Al, or a combination thereof.

10. The sodium battery of claim 8, wherein said protecting layer comprises a carbon material, graphene, a polymer, or a sodium- or sodium-containing species chemically bonded to said particulates and said sodium- or sodium-containing species is selected from Li₂CO₃, Li₂C₂O₄, LiOH, LiCl, LiI, LiBr, ROCO₂Li, HCOLi, ROLi, (ROCO₂Li)₂, (CH₂OCO₂Li)₂, Li₂S, LiₓSO_{y}, Li₄B, Na₄B, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, Li₂O, Na₂O, NaF, LiF, a combination thereof, wherein X═F, Cl, I, or Br, R=a hydrocarbon group, x=0-1, y=1-4.

11. The sodium battery of claim 8, wherein said protecting layer comprises a thin layer of a high-elasticity polymer having a fully recoverable tensile strain from 5% to 1,000%, and a sodium ion conductivity from 10⁻⁷ S/cm to 5×10⁻² S/cm at room temperature.

12. The sodium battery of claim 1, wherein said electrolyte is selected from solid polymer electrolyte, polymer gel electrolyte, composite electrolyte, ionic liquid electrolyte, non-aqueous organic liquid electrolyte, soft matter phase electrolyte, inorganic solid-state electrolyte, or a combination thereof.

13. The sodium battery of claim 1, wherein said electrolyte contains a salt selected from an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), a combination thereof, or a combination thereof with lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF3(CF₂CF₃)₃), or lithium bisperfluoroethysulfonylimide (LiBETI).

14. The sodium battery of claim 12, wherein said electrolyte comprises a solvent selected from ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol)dimethyl ether (PEGDME), diethylene glycol dibutyl ether (DEGDBE), 2-ethoxyethyl ether (EEE), sulfone, sulfolane, a room temperature ionic liquid, or a combination thereof.

15. The sodium battery of claim 1, wherein the cathode comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ—MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

16. The sodium battery of claim 1, wherein the cathode comprises a cathode active material selected from a Na-based layered oxide, a polyanionic compound, a mixed polyanionic compound, a sulfate, a pyrophosphate, a Prussian Blue analog, or a combination thereof.

17. The sodium battery of claim 1, wherein the cathode comprises a cathode active material selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2} Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide-protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

18. The sodium battery of claim 1, wherein the sodium battery comprises a sodium-ion cell, sodium-sulfur cell, sodium-selenium cell, or a sodium-air cell.

19. A process for producing a solid powder mass of multiple individual M-containing porous particulates of claim 1, said process comprising (a) providing a solid powder mass comprising multiple porous host particles having a volume fraction of pores from 5% to 99.9%, wherein the porous host particles are electrically conducting having an electrical conductivity of no less than 10⁻⁶ S/cm; (b) introducing a reactive liquid or solution, containing a M precursor, into pores of said porous particles, and (c) exposing said reactive liquid or solution species to heat, ultra-violet light, laser beam, high-energy radiation, or a combination thereof to chemically convert said M precursor into M particles residing in said pores or M coating deposited on pore walls to obtain the solid powder mass of separate multiple M-containing porous particulates, where M is an element selected from Ge, Sn, Sb, Pb, P, Bi, an alloy thereof, a compound thereof, or a combination thereof.

20. The process of claim 19, further comprising a procedure of encapsulating or coating the porous anode material particulates with a thin protecting layer having a thickness from 0.5 nm to 2 μm, wherein the protecting layer comprises carbon, graphene, electron-conducting polymer, sodium ion-conducting polymer, or a combination thereof.

21. The process of claim 19, further comprising a procedure of pre-sodiating the M coating or M particles in the pores of the multiple particulates, wherein said Si coating or particles are pre-sodiated to contain an amount of sodium from 1% to 100% of a maximum sodium content contained in M.

22. The process of claim 21, further comprising a procedure of encapsulating or coating the pre-sodiated multiple anode material particulates with a thin protecting layer having a thickness from 0.5 nm to 2 μm.

23. The process of claim 21, wherein said step of pre-sodiating includes a procedure selected from chemical pre-sodiation, electrochemical sodiation, solution sodiation, physical sodiation, or a combination thereof.

24. The process of claim 19, further comprising a step of forming said multiple M-containing porous particulates, along with an optional binder and optional conductive additive, into an anode electrode.

25. The process of claim 24, further comprising a step of combining said anode electrode with a cathode, and an electrolyte to form a sodium battery cell.

26. A process for producing a solid powder mass of multiple individual anode material particulates of claim 1, said process comprising (a) providing a working electrode comprising a solid powder mass comprising multiple porous host particles having a volume fraction of pores from 5% to 99.9%, wherein the porous host particles are selected from carbonaceous, graphitic, graphene, or metallic particles; (b) dissolving or dispersing a source of a selected anode active material in a liquid electrolyte; (c) providing a counter electrode; and (d) disposing the working electrode, the liquid electrolyte, and the counter electrode in a first electrodeposition chamber and applying a desired current or voltage sequence across the working electrode and the counter electrode to electrodeposit an anode active material into the pores of the porous particles to obtain the solid powder mass of separate multiple anode material particulates.

27. The process of claim 26, wherein the anode active material is selected from silicon (Si), germanium (Ge), tin (Sn), Phosphorus (P), lead (Pb), antimony (Sb), bismuth (Bi), or a combination thereof.

28. The process of claim 26, wherein the anode active material source comprises a material selected from SiCl₄, GeCl₄, SnCl₄, SiBr₄, GeBr₄, SnBr₄, SiI₄, GeI₄, SnI₄, SiHCl₃, GeHCl₃, SnHCl₃, SiHBr₃, GeHBr₃, SnHBr₃, SiHI₃, GeHI₃, SnHI₃, a salt of Si, Ge, Sn, P, Pb, Sb, Bi, Zn, Al, Ti, Ni, Co, Mn, Cd, or a combination thereof.
